(19) United States
(12) Patent Application Publication
(10) Pub. No.: US 2016/0023219 A1
(43) Pub. Date: Jan. 28, 2016

(54) Sluice Box

(71) Applicant: Siya, Inc., Santa Fe Springs, CA (US)

(72) Inventor: Sudhir Mundhra, Cerritos, CA (US)

(73) Assignee: Siya, Inc.

(21) Appl. No.: 14/809,050

(22) Filed: Jul. 24, 2015

Related U.S. Application Data
(60) Provisional application No. 62/029,124, filed on Jul. 25, 2014.

(51) Int. Cl. B03B 5/26

(52) U.S. Cl. CPC B03B 5/26

(57) ABSTRACT

A sluice box having riffles of varying patterns and profiles to increase the chances of recovering gold particles and other precious ores. The riffles are contained in a sluice bed. The sluice bed is attached to a diverter to divert the water through the sluice bed.

### CROSS-REFERENCE TO RELATED APPLICATION

This patent application claims the benefit of United States Provisional Patent Application Ser. No. 62/029,124, entitled “Sluice Box,” filed Jul. 25, 2014, which application is incorporated in its entirety here by this reference.

### TECHNICAL FIELD

This invention relates to filtering devices for separating one type of particle from another, such as ores, precious stone, and the like, from dirt, sand, soil, and the like.

### BACKGROUND

Mining for gold, although not as popular as it once was, is still practiced by the general public as a form of recreation, hobby, or entertainment Some may even still rely upon the process as a form of income. Mining for gold can be performed in a safe and economic way by using techniques such as panning, rocking, sluicing, and variations thereof.

Specialized pans or sluice boxes are often used. Sluice boxes generally contain uniform riffles along the bottom. Deposits are placed in the sluice box and water is passed through the sluice box. As the water transports the deposit across the riffles, the heavier gold particles are trapped in between the riffles while the other, unwanted material is washed away. Unfortunately, much of the unwanted material remains in between the riffles. Increasing the water flow may help wash away more of the unwanted material, but increases the probability of losing the gold particles and other precious materials, while removing the unwanted material.

For the foregoing reasons there is a need for an improved sluice box that will increase the chances of retaining the gold particles and other precious materials, while removing the unwanted material.

### SUMMARY

The present invention is directed to a sluice box having a sluice bed containing riffles of varying patterns and profiles to increase the chances of retaining gold particles, and other precious ore, while more effectively removing the unwanted material. The sluice box may further comprise diverter to help transfer water through the sluice bed.

### BRIEF DESCRIPTION OF DRAWINGS

FIG. 1 is a perspective, top view of the present invention.

FIG. 2 is a top view of an embodiment of the present invention.

FIG. 3 is an exploded view of an embodiment of the present invention.

FIG. 4 is a side view of an embodiment of the present invention.

FIG. 5 shows the presently preferred profiles for the ribs. The flow direction is from left to right in the figure, and the ribs are not necessarily shown to scale.

FIG. 6 is a first riffle pattern showing one way to combine the three rib profiles of FIG. 5. The flow direction is from left to right in the figure, and the ribs are not necessarily shown to scale.

FIG. 7 is a second riffle pattern showing a second way to combine the three rib profiles of FIG. 5. The flow direction is from left to right in the figure, and the ribs are not necessarily shown to scale.

FIG. 8 is a third riffle pattern showing a third way to combine the three rib profiles of FIG. 5. The flow direction is from left to right in the figure, and the ribs are not necessarily shown to scale.

### BEST MODE FOR CARRYING OUT THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

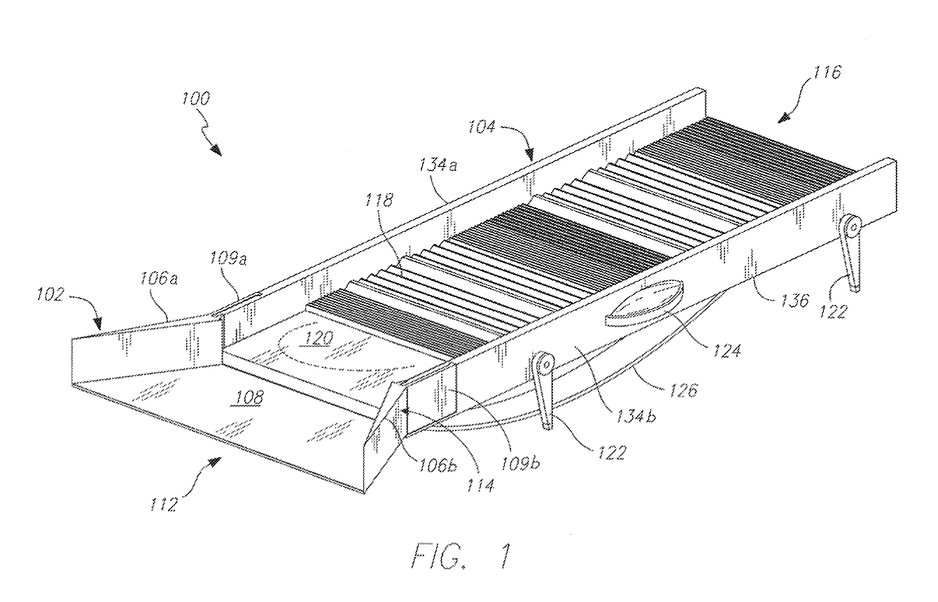

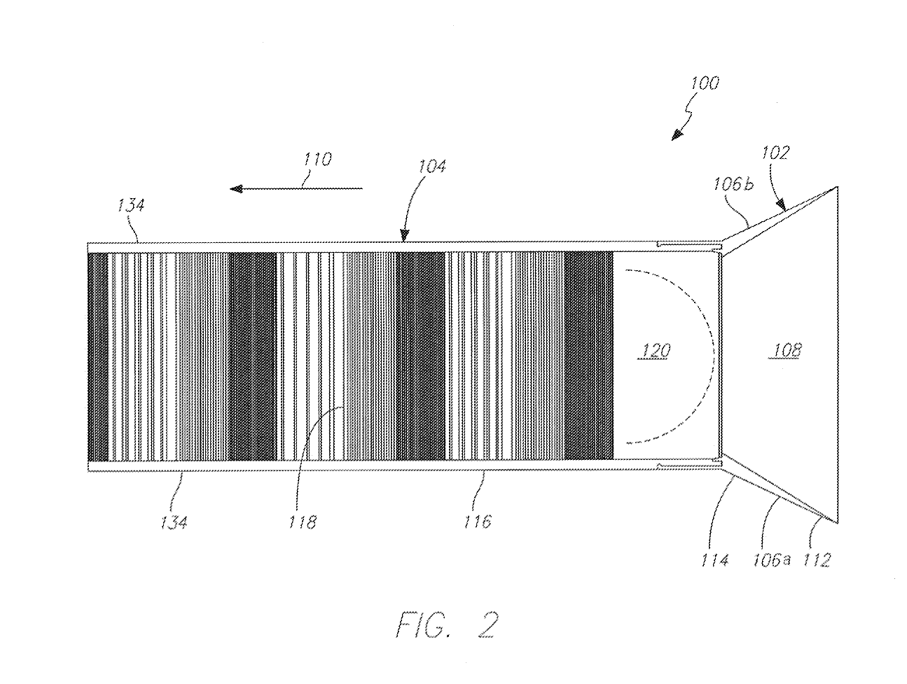

Referring to FIGS. 1-3, a sluice box 100 comprises a diverter 102 and a sluice bed 104 to convey water and separate particles from the water. For example, the sluice box 100 may be used for placer mining, where gold or other minerals are separated from less dense debris by flushing water over placer ore.

The diverter 102 collects water from a stream or other water source and diverts the water into the sluice bed 104. The diverter 102 comprises two opposing side walls 106a, 106b and a bottom 108. The diverter bottom 108 is preferably smooth and connected to the side walls 106a, 106b. The side walls 106a, 106b define an upstream end 112 and a downstream end 114 opposite the upstream end 112. In the preferred embodiment, the side walls 106a, 106b converge in a flow direction 110 so that the cross-sectional area of the diverter 102 at the upstream end 112 is greater than the cross-sectional area at the downstream end 114 of the diverter 102. That is, the upstream end 112 is flared, thereby creating a tapering of the diverter 102 from the upstream end 112 towards the downstream end 114, which facilitates the transference of water from the water source to the sluice bed 104. The diverter 102 is operatively connected to the sluice bed 104. For example, the diverter 102 may comprise fastening members 109a, 109b to connect the diverter 102 to the sluice bed 104. In another example, the diverter 102 is operatively connected to the sluice bed 104 by being integrally formed with the sluice bed 104 as a one-piece unit.

The sluice bed 104 conveys the water and placer ore in the flow direction 110, allowing gravity to separate particles from the water. The sluice bed 104 comprises a sluice channel 116 and riffles 118. In some embodiments, the sluice bed 104 comprises a drop zone 120. In some embodiments, the drop zone 120 is in the diverter 102. The sluice channel 116 provides a conduit for the water and placer ore to move in the flow direction 110. The sluice channel 116 includes a pair of side walls 134a,134b and a bottom 136 operatively connected to the pair of side walls 134a, 134b. The riffles 118 may be operatively connected to the bottom 136, meaning the riffles 118 may be attached to the bottom 136, or be integrally formed as a part of the bottom 136.

The drop zone 120 is that part of the sluice bed that is immediately upstream of the riffles 118. In normal use, placer ore is positioned here (for example, by delivering a scoop from a hand shovel) to be conveyed by the water in the flow direction 110.

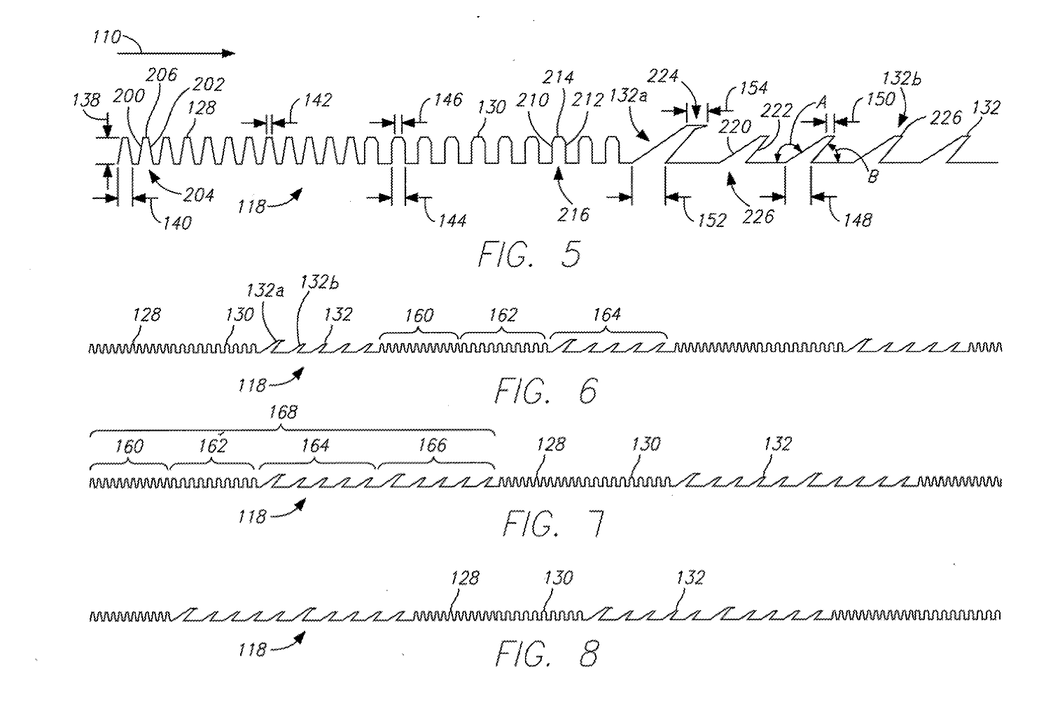

The riffles 118 comprise a series of ribs having various cross-sectional profiles. Examples of the cross-sectional profiles are shown in FIGS. 5 to 8. Depicted in FIG. 5 are the three presently preferred profiles for the ribs. From left to right in FIG. 5 are an A-frame profile 128, an arch profile 130, and a raked fin profile 132. These profiles can be mixed in a variety of ways and other profiles are possible.

Each rib is characterized by a base, a top, and front and back walls therebetween. The distance from the back wall to the frontwall at the base is referred to as the base width. The distance from the back wall to the front wall at the top is referred to as the top width. The distance from the top to the base is referred to as the height.

The A-frame profile 128 is characterized by nonparallel front and back walls 200, 202 that taper from the base 204 towards the top 206. Therefore, the A-frame profile 128 has an isosceles triangle appearance with the base width 140 wider than the top width 142. The top 206 is generally flat having a top surface parallel to the bottom 136 of the sluice channel 116. In some embodiments, the top 206 may terminate at the sharp point. In some embodiments, the top surface may be textured or have a convex curvature so as to increase the obstruction of the flow of water. In the preferred embodiment, each rib 118 having an A-frame profile 128 preferably has a base width 140 ranging from about 3.0 mm to about 4.0 mm, but perfectly 3.5 mm. The top width 142 may range from about 1.0 mm to about 1.5 mm, but preferably is 1.27 mm. The distance between the base 204 of one A-frame profile rib and the next, adjacent A-frame profile rib ranges from about 1.0 mm to about 1.5 mm, but preferably is about 1.38 mm.

The ribs having an arch profile 130 are characterized by parallel front and back walls 210, 212 that are perpendicular to the bottom 136 of the sluice channel 116. As the front and back walls 210, 212 approach the top 214, the front and back walls 210, 212 gradually converge toward each other either as a straight taper or through a curvature. Preferably, the top 214 of the arch profile 130 is also flat, thereby being parallel to the bottom 136 of the sluice channel 116. However, the top 214 may have a textured surface, or concave surface to disrupt the flow of water. In the preferred embodiment, each rib having an arch profile 130 preferably has a base width 144 ranging from about 2.8 mm to about 3.5 mm, but preferably 3.14 mm; and a top width 146 ranging from about 1.2 mm to about 2.0 mm, but preferably 1.61 mm. The distance between the base 216 of one arch profile rib to the next, adjacent arch profile rib ranges from about 2.8 mm to about 3.5 mm, but is preferably about 3.16 mm.

The ribs having a raked fin profile 132 are characterized by front and back walls 220, 222 angled in the same direction. As such, the front wall 220 defines an obtuse angle A with the bottom 136 of the sluice channel 116, and the back wall 222 defines an acute angle B with the bottom 136 of the sluice channel 116. In the preferred embodiment, the raked fin profile 132 comprises two types, a major raked fin profile 132a and a minor raked fin profile 132b. The major raked fin profile 132a has a base width, a height, and a top width that is greater than the base width, height, and top width respectively, of the minor raked fin profile 132b. In addition, the major raked fin profile 132a has a bent apex 224 terminating at a sharp tip that is substantially parallel to the bottom 136 of the sluice channel 116. Therefore, the bent apex 224 of the major raked fin 132a overhangs beyond the back wall 222. The minor raked fin 132b terminates at the top 226 with a flat surface that is parallel to the bottom 136 of the sluice channel 116. But like the other ribs, the raked fin profile 132 may have top surfaces that are concave or textured to further disrupt the flow of water.

As shown in FIG. 6, one series of the raked in profile ribs 132 may comprise one major raked fin 132a followed by a plurality of minor raked fins 132b. The major raked fin 132a is upstream of the minor raked fins 132b within a series. In the preferred embodiment, the major raked fin 132a (in each set of raked fins) has a height of about 8 mm. The minor raked fins 132a have a height about 6 mm. The major raked fins 132a have a base width 152 ranging from about 7.5 mm to about 8.5 mm, and preferably 7.9 mm; and a top width 154 ranging from about 4.5 mm to about 5.5 mm, and preferably about 4.97 mm. The minor raked fins 132a have a base width 148 ranging from about 2.5 mm to about 3.5 min, and preferably 3.14 mm; and a top width 150 of about 1.95 mm. The distance between the base 226 of one raked fin to the next adjacent raked fin is about 12 mm to about 14 mm. Preferably the distance between two adjacent raked fins is about 12.9 mm to about 13.5 mm.

Therefore, overall, each rib preferably has a height 138 ranging from about 4 mm to about 10 mm. Preferably, the ribs have a height 138 ranging from about 6 mm to about 8 mm. The base of each rib preferably have a base width ranging from about 3 mm to about 8 mm. The top width ranges from about 1.2 mm to about 5 mm.

In a preferred pattern, as shown in FIG. 6, one series of ribs 160 has an A-frame profile 128 with the ribs repeating for about 58.6 mm followed by a second series of ribs 162 having an arch profile 130 with the ribs repeating for about 63.0 mm that is, in turn, followed by a third series of ribs 164 having a raked fin profile 132 with the ribs repeating for about 85.0 mm. This pattern can then be repeated, starting with the ribs having an A-frame profile 128.

As shown in FIG. 7, in another embodiment, a first series of ribs 160 containing the A-frame profile 128 may be followed by a second series of ribs 162 containing the arched profile 130, which in turn is followed by a third series of ribs 164 containing the raked fin profile 132, 132a, followed by a fourth series of ribs 166 repeating the raked fin profile 132. This set 168 can be repeated throughout the sluice channel.

The different profile series can be organized in a variety of different arrangements, and even in a random arrangement. In FIG. 8, at one section of the channel 116, the raked fin profile series 132 follows the A-frame profile series 128 rather than the arched profile series 130. At a different section along the channel 116, the raked fin profile series 132 follows the arched profile series 130.

Each rib in the riffles 118 creates a barrier to the flow of water in the flow direction 110 and a section of relatively slower flow immediately adjacent to the rib. As such, denser materials in the flow (such as gold) tend to sink to the bottom of the sluice bed 104 and come to rest between the ribs. In this way, gravity is used to separate particles from the water. Generally, the user may need to adjust the angle of the sluice bed 104 (meaning the gradient from the upstream end to the downstream end), the flow rate of water through the sluice box 100, or both to optimize the process of separating particles from the water,

Alternatively, placer ore may be placed in the drop zone 120 of the sluice bed 104 and water (from a hose, stream, tank, or other water source) may be directed over and through the ore in the flow direction 110.

In some versions, the drop zone 120 is part of the diverter 102 instead of the sluice bed, and the sluice bed 104 has riffles 118 along substantially the entire length of the sluice bed 104.

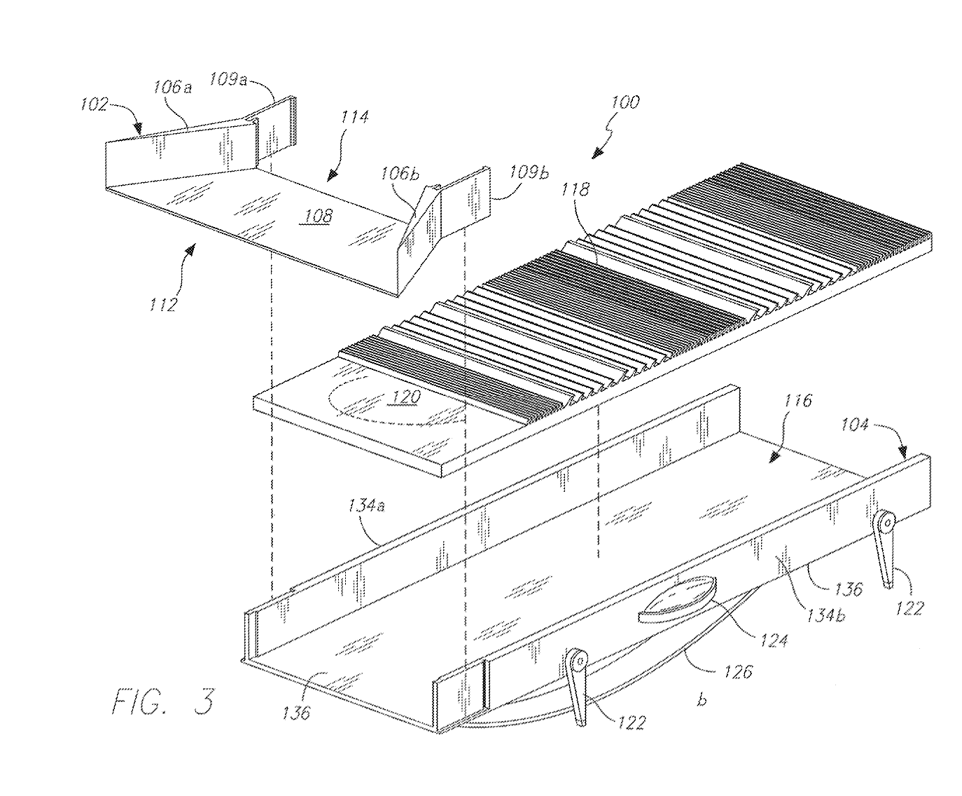

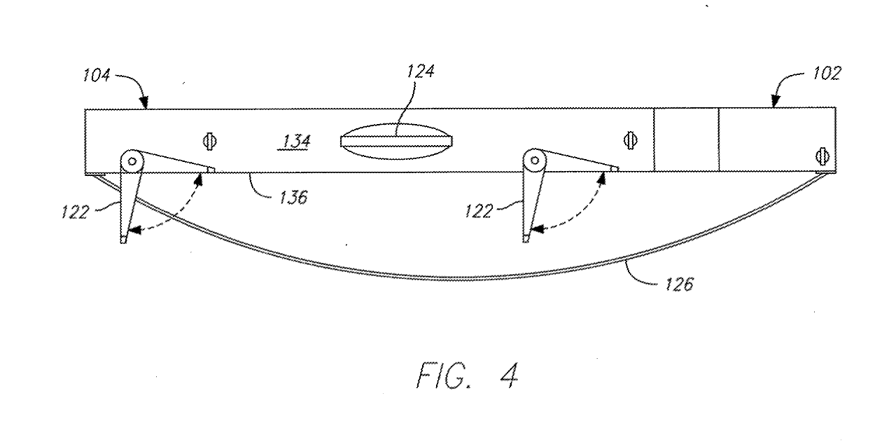

As shown in FIG. 4, in a version of the sluice box 100, the sluice box 100 includes legs 122 to support the sluice box 100 over a surface, such as a streambed, The legs 122 can also be used to stake the sluice box in place while in use, for example, in a flowing stream. Without the legs 122, the sluice box 100 might be pushed downstream by the force of the flowing water, But by pushing the legs 122 into the streambed, the sluice box 100 is secured. The legs 122 can also be used to adjust and set the angle of the sluice bed 104. Preferably, each leg 122 is pivotally attached to the underside of the sluice bed 104. In this way, each leg 122 can be pivoted out and away from the sluice bed 104 when needed and pivoted in toward the sluice bed 104 when not needed.

In a version of the sluice box 100, the sluice box 100 includes a handle 124. The handle 124 is preferably attached to a side wall 134 of the sluice bed 104 to permit carrying of the sluice box 100 with one hand, like one would hold a briefcase. The handle 124 also facilitates positioning of the sluice box 100 during use by providing a grip for the user to grasp. This is particularly useful when the sluice box 100 is underwater, as it would be during normal use in a streambed, since the smooth surfaces of the sluice box 100 may be difficult to grasp under such conditions.

In a version of the sluice box 100, the sluice box 100 includes a carrying strap 126. The carrying strap 126 may be in the form of a shoulder strap. Preferably, carrying strap 126 is a set of padded backpack straps to allow the sluice box 100 to be cinched over the user's shoulders and carried on the user's back. In such a version, the backpack straps are attached at the upstream and downstream ends of the sluice bed 104. The carrying strap 126 may also be detachable, so that the carrying strap 126 can be removed when the sluice box 100 is submerged in a streambed. In this way the carrying strap 126 can be kept out of the water and dry.

The sluice box 100 can be made from a variety of materials, but lighter weight materials, such as aluminum, plastic, and composites, are preferred because of their relatively high strength-to-weight ratio. Most preferably, sluice box 100 is manufactured from UV-resistant, molded plastic, which permits good durability, light weight, and a relatively low cost to manufacture and ship the finished sluice box 100. It is important that the sluice box 100 be lightweight enough to be easily carried by the user, particularly by either the handle 124 or the carrying strap 126. Also, by using molded plastic, the sluice bed 104 can be made in one piece to reduce manufacturing and assembly costs.

By way of example only, in one embodiment, the entire length of the sluice box 100 is 914.40 mm. The length of the sluice channel 160 is 775.60 mm. The riffles 118 span a distance of 647.70 mm. The upstream end 112 of the diverter 102 may have a width of 410.72 mm. The width of the sluice channel 160 is 279.40 mm. The width of the riffles 118 is 254.00 mm. The height of the sluice box 100 is 70.20 mm.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A sluice box, comprising:
a) a diverter to collect water from a water source, the diverter comprising:
(i) two opposing side walls defining an upstream end and a downstream end opposite the upstream end, wherein a cross-sectional area of the diverter at the upstream end is greater than the cross-sectional area of the diverter at the downstream end, thereby creating a tapering of the diverter from the upstream end towards the downstream end, and
(ii) a bottom having a smooth interior side;
b) a sluice bed operatively connected to the diverter to convey water and separate particles from the water, the sluice bed comprising:
(i) a sluice channel defined by a pair of side walls and a bottom, and
(ii) riffles operatively connected to the bottom of the sluice channel,
(ill) wherein the riffles comprise a first series of ribs having an A-frame profile that repeats for about 58.6 millimeters, a second series of ribs having an arch profile that repeats for about 63.0 millimeters, and a third series of ribs having a raked fin profile comprising a major raked fin followed by a plurality of minor raked fins, the third series of ribs extending for about 85.0 millimeters, wherein the first series of ribs is adjacent to the second series of ribs, and the second series of ribs is adjacent to the third series of ribs, wherein each rib in the first, second, and third series of ribs has a height of about six millimeters to about eight millimeters, a base width of about 3 millimeters to about 8 millimeters, and a top width of about 1.2 millimeters to about 5 millimeters;
c) a drop zone upstream of the riffles and downstream from the upstream end of the diverter;
d) adjustable legs pivotally attached to the sluice bed to support the sluice box over a surface;
e) a handle attached to the sluice bed to permit carrying of the sluice box; and
f) a detachable carrying strap.

2. A sluice box, comprising a sluice bed to convey water and separate particles from the water, the sluice bed comprising:
a) a sluice channel defined by a pair of side walls and a bottom; and
b) riffles operatively connected to the bottom of the sluice channel,
c) wherein the riffles comprise a first series of ribs having an A-frame profile, a second series of ribs having an arch profile, and a third series of ribs having a raked fin profile.

3. The sluice box of claim 2, wherein the third series of ribs comprises a major raked fin followed by a plurality of minor raked fins.

4. The sluice box of claim 3, wherein the major raked fin comprises a bent apex terminating a sharp tip substantially parallel to the bottom of the sluice channel.

5. The sluice box of claim 4, wherein each rib in the third series of ribs comprises a front wall, and a back wall opposite the front wall, the front wall creating an obtuse angle with the bottom of the sluice channel, and the back wall creating an accute angle with the bottom of the sluice channel.

6. The sluice box of claim 5, wherein the third series of ribs extends for about 85.0 millimeters.

7. The sluice box of claim 6, wherein the third series of ribs repeats at least once.

8. The sluice box of claim 2, wherein the first series of ribs is adjacent to the second series of ribs, and the second series of ribs is adjacent to the third series of ribs.

9. The sluice box of claim 8, wherein each rib in the first, second, and third series of ribs has a height of about six millimeters to about eight millimeters, a base width of about 3 millimeters to about 8 millimeters, and a top width of about 1.2 millimeters to about 5 millimeters;

10. The sluice box of claim 9, wherein the first series of ribs extends for about 58.6 millimeters, the second series of ribs extends for about 63.0 millimeters, and the third series of ribs extends for about 85.0 millimeters.

11. The sluice box of claim 2, further comprising a drop zone upstream of the riffles.

12. The sluice box of claim 2, further comprising a diverter operatively connected to the sluice channel to divert water from a water source to the sluice channel.

13. The sluice box of claim 12, wherein the diverter comprises two opposing side walls defining an upstream end and a downstream end opposite the upstream end, wherein a cross-sectional area of the diverter at the upstream end is greater than the cross-sectional area of the diverter at the downstream end, thereby creating a tapering of the diverter from the upstream end towards the downstream end.

14. The sluice box of claim 2, further comprising adjustable legs pivotally attached to the sluice bed to support the sluice box over a surface.

15. The sluice box of claim 2, further comprising a handle attached to the sluice bed to permit carrying of the sluice box.

16. The sluice box of claim 2, further comprising a carrying strap.

17. A method of separating particles from water, comprising:
a) placing placer ore into a drop zone of a sluice box comprising a multiple series of riffles, each series of riffles comprising a plurality of ribs wherein the ribs in a first series of ruffles has a first profile, and the ribs in a second series has a second profile different from the first profile; and
b) causing water to flow through the sluice box in a flow direction,
c) wherein the riffles create barriers to the flow of water in the flow direction and a section of relatively slower flow immediately adjacent to the ribs causing denser materials in the flow direction to sink to a bottom of the sluice bed and come to rest between the ribs.

18. The method of claim 17, wherein an angle of the sluice bed is adjusted.

19. The method of claim 17, wherein a flow rate of water through the sluice box is adjusted.

20. The method of claim 17, wherein the riffles comprise a first series of ribs having an A-frame profile, a second series of ribs having an arch profile, and a third series of ribs having a raked fin profile.
